(19) United States
(12) Patent Application Publication
(10) Pub. No.: US 2025/0358861 A1
(43) Pub. Date: Nov. 20, 2025

(54) METHOD AND APPARATUS FOR SELF-OPTIMIZATION OF RANDOM ACCESS CHANNEL IN WIRELESS COMMUNICATION SYSTEM

(71) Applicant: SAMSUNG ELECTRONICS CO., LTD., Suwon-si, Gyeonggi-do (KR)

(72) Inventor: Aby Kanneath ABRAHAM, Bangalore (IN)

(21) Appl. No.: 18/872,387

(22) PCT Filed: Jun. 8, 2023
(86) PCT No.: PCT/KR2023/007828

§ 371 Date: Dec. 6, 2024

(30) Foreign Application Priority Data
Jun. 10, 2022 (IN) 202241033271
May 5, 2023 (IN) 202241033271

(51) Int. Cl. H04W 74/0833

(52) U.S. Cl. CPC H04W 74/0833

(57) ABSTRACT

The disclosure relates to a 5G or 6G communication system for supporting a higher data transmission rate. The method for self-optimization of RACH includes storing a feature specific RACH information corresponding to a feature specific RACH applied by the UE for one of multiple features of a plurality of features and a specific feature of the plurality of features. Further, the method includes receiving an information request message from a network apparatus. Further, the method includes including the feature specific RACH information corresponding to the feature specific RACH applied by the UE for one of the multiple features and the specific feature in an information response message for self-optimization of the RACH. Further, the method includes sending the information response message includes the feature specific RACH information corresponding to the feature specific RACH applied by the UE to the network apparatus in the wireless network.

### TECHNICAL FIELD

The disclosure relates to the field of wireless communication. More particularly, the disclosure relates to methods and systems for self-optimization of random access in the wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

This disclosure relates to wireless communication networks, and more particularly to a terminal and a communication method thereof in a wireless communication system.

In accordance with an aspect of the disclosure, the principal object of the embodiments herein is to provide methods and a wireless network for self-optimization of random access.

Another object of the embodiments herein is to perform SON RACH including for slice groups, msg3 and the reporting of additional parameters for feature specific RACH in the wireless network.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The method, the UE and the network apparatus are illustrated in the accompanying drawings, throughout which like reference letters indicate corresponding parts in the various figures. The embodiments herein will be better understood from the following description with reference to the drawings, in which:

FIG. 1 illustrates an overview of a wireless network for self-optimization of RACH, according to the embodiments as disclosed herein;

FIG. 2 shows various hardware components of a UE, according to the embodiments as disclosed herein;

FIG. 3 shows various hardware components of a base station, according to the embodiments as disclosed herein;

FIG. 4 is a flow chart illustrating a method, implemented by the UE, for self-optimization of RACH in the wireless network, according to the embodiments as disclosed herein;

FIG. 5 is a flow chart illustrating a method, implemented by the network apparatus, for self-optimization of RACH in the wireless network, according to the embodiments as disclosed herein;

FIG. 6 is a flow chart illustrating a scenario of logging and reporting feature specific random access information in the UE, according to the embodiments as disclosed herein;

FIG. 7 is a flow chart illustrating a scenario of logging and reporting feature specific random access information in the UE for NSAG, according to the embodiments as disclosed herein;

FIG. 8 is a flow chart illustrating a scenario of logging and reporting feature specific random access information in the UE for msg3 repetitions, according to the embodiments as disclosed herein; and

FIG. 9 illustrates a scenario of reporting feature specific RACH information to gNB, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the one or more elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

Accordingly, the embodiment herein is to provide a method for self-optimization of RACH in a wireless network. The method includes detecting, by a UE, a network event in the wireless network. Further, the method includes storing, by the UE, a feature specific RACH information corresponding to a feature specific RACH applied by the UE for one of multiple features of a plurality of features and a specific feature of the plurality of features. The plurality of features includes a Small Data Transmission, coverage enhancement (i.e. msg3 repetition), a Reduced Capacity (Redcap) and network slicing. Further, the method includes receiving, by the UE, an information request message from a network apparatus. Further, the method includes including, by the UE, the feature specific RACH information corresponding to the feature specific RACH applied by the UE for one of the multiple features and the specific feature in an information response message for self-optimization of the RACH. Further, the method includes sending, by the UE, the information response message includes the feature specific RACH information corresponding to the feature specific RACH applied by the UE to the network apparatus in the wireless network.

In an embodiment, the feature specific RACH information corresponding to the feature specific RACH applied by the UE for the multiple features includes a list of features for which the feature specific RACH is applied, a priority associated with each feature in the list of features. The priority is provided by at least one of explicitly logging and reporting a feature priority received from the network apparatus and by implicitly providing a relative priority by logging and reporting the features in a priority order, and at least one parameter received in an additional RACH configuration. The priority order may be ascending order of priorities. Alternatively, the priority order may be descending order of priorities. The parameter received in the additional RACH configuration is zero or more parameters depending on the configuration. In an example, the parameter from the additional RACH configuration include msg1-SCS-From-prach-ConfigurationIndex, msg1-SubcarrierSpacing-r16 etc.

In an embodiment, the feature specific RACH information corresponding to the feature specific RACH applied by the UE for the multiple features includes at least one parameter received in a Feature Combination Preamble. The at least one parameter includes at least one of a msgA-MCS, nrofPRBs-PerMsgA-PO, msgA-PUSCH-TimeDomainAllocation, frequencyStartMsgA-PUSCH, nrofMsgA-PO-FDM and msgA-SubcarrierSpacing. The FeatureCombinationPreamble is the FeatureCombinationPreamble corresponding to the combination of features used by the UE for performing this random access.

In an embodiment, the feature specific RACH information corresponding to the feature specific RACH applied by the UE for the specific feature related to the network slicing includes a list of all Network Slice AS groups (NSAGs) that are used/applied for the feature specific random access at the UE and NSAG priority of the NSAGs as received from a core network.

In an embodiment, the feature specific RACH information includes whether the UE has used Multimedia Priority Service (MPS) or Mission Critical Service (MCS) specific RACH prioritization, whether the UE has used slicing based RACH prioritization for random access, and a scaling Factor BI for the network slicing or MPS or MCS, power ramping step high priority for the MPS or MCS, power ramping step high priority for the NSAG used for selecting the feature specific RACH related to the network slicing, whether there was a collision between MPS or MCS and NSAG based RACH, scalingFactorBI for the NSAG used for selecting slice based RACH, powerRampingStepHighPriority for the NSAG used for selecting slice based RACH, scalingFactorBI for MPS/MCS and powerRampingStepHighPriority for MPS/MCS.

In an embodiment, the feature specific RACH information corresponding to the feature specific RACH applied by the UE for the specific feature related to the msg3 repetition includes a number of msg3 repetitions performed, and a number of msg3 repetitions requested by the network apparatus to be performed, and a MCS used for the msg3 repetitions, and information about whether the msg3 repetitions terminated based on Layer 1 inputs.

Accordingly, the embodiment herein is to provide a method for self-optimization of RACH in a wireless network. The method includes sending, by a network apparatus in the wireless network, an information request message to a UE in the wireless network. Further, the method includes receiving, by the network apparatus, an information response message comprising a feature specific RACH information corresponding to a feature specific RACH applied by the UE for one of multiple features of a plurality of features and a specific feature of the plurality of features from the UE, where the plurality of features includes a SDT, coverage enhancement, a Redcap, network slicing, and msg3 repetition. Further, the method includes optimizing, by the network apparatus, at least one network parameter related to random access (RA) based on the feature specific RACH information received from the UE and a criteria for using the feature specific RACH.

Accordingly, the embodiment herein is to provide a UE for self-optimization of RACH in a wireless network. The UE includes a feature specific RACH controller communicatively coupled to a memory and a processor. The feature specific RACH controller is configured to detect a network event in the wireless network. Further, the feature specific RACH controller is configured to store a feature specific RACH information corresponding to a feature specific RACH applied by the UE for one of multiple features of a plurality of features and a specific feature of the plurality of features. The plurality of features includes a SDT, coverage enhancement (i.e., msg3 repetition), a Redcap and network slicing. Further, the feature specific RACH controller is configured to receive an information request message from a network apparatus. Further, the feature specific RACH controller is configured to include the feature specific RACH information corresponding to the feature specific RACH applied by the UE for one of the multiple features and the specific feature in an information response message for self-optimization of the RACH. Further, the feature specific RACH controller is configured to send the information response message comprising the feature specific RACH information corresponding to the feature specific RACH applied by the UE to the network apparatus in the wireless network.

Accordingly, the embodiment herein is to provide a network apparatus for self-optimization of RACH in a wireless network. The network apparatus includes a feature specific RACH controller communicatively coupled to a memory and a processor. The feature specific RACH controller is configured to send an information request message to a UE in the wireless network. Further, the feature specific RACH controller is configured to receive an information response message comprising a feature specific RACH information corresponding to a feature specific RACH applied by the UE for one of multiple features of a plurality of features and a specific feature of the plurality of features from the UE. The plurality of features includes a SDT, coverage enhancement (i.e., msg3 repetition), a Redcap and network slicing. Further, the feature specific RACH controller is configured to optimize at least one network parameter related to RA based on the feature specific RACH information received from the UE and a criteria for using the feature specific RACH.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Mode for the Invention

In a 5^{th} Generation (5G) wireless communication system, random access (RA) is supported. The RA is used to achieve uplink (UL) time synchronization. The RA is used during initial access, handover, radio resource control (RRC) connection re-establishment procedure, scheduling request transmission, secondary cell group (SCG) addition/modification, beam failure recovery and data or control information transmission in the UL by non-synchronized User Equipment (UE) in a RRC CONNECTED state. Several types of random access procedure is supported.

Contention Based Random Access (CBRA)—In this type of random access, the UE first transmits Random Access preamble (also referred as Msg1) and then waits for a Random access response (RAR) in a RAR window. The RAR is also referred as Msg2. Next generation node B (e.g., gNB or the like) transmits the RAR on a physical downlink shared channel (PDSCH). A PDCCH (physical downlink control channel) scheduling the PDSCH carrying RAR is addressed to RA-radio network temporary identifier (RA-RNTI). The RA-RNTI identifies a time-frequency resource (also referred as physical RA channel (PRACH) occasion or PRACH transmission (TX) occasion or RA channel (RACH) occasion) in which RA preamble is detected by the gNB.

If the RAR corresponding to its RA preamble transmission is received, the UE transmits message 3 (Msg3) in a UL grant received in the RAR. The Msg3 includes message such as RRC connection request, RRC connection re-establishment request, RRC handover confirm, scheduling request, system information (SI) request etc. The Msg3 includes the UE identity (i.e. cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to C-RNTI included in the Msg3, contention resolution is considered successful, contention resolution timer is stopped and RA procedure is completed. While the contention resolution timer is running, if the UE receives contention resolution a MAC control element (CE) including the UE's contention resolution identity (first X bits of common control channel (CCCH) service data unit (SDU) transmitted in Msg3), the contention resolution is considered successful, the contention resolution timer is stopped and the RA procedure is completed. If the contention resolution timer expires and the UE has not yet transmitted the RA preamble for a configurable number of times, the UE goes back to first step i.e. select random access resource (preamble/RACH occasion) and transmits the RA preamble. A backoff may be applied before going back to first step.

Contention Free Random Access (CFRA): The CFRA is also referred as legacy CFRA or 4 step CFRA. The CFRA procedure is used for scenarios such as handover where low latency is required, timing advance establishment for secondary cell (Scell), etc. A 5G node B (e.g., gNB or the like) assigns to a UE dedicated Random access preamble. The UE transmits the dedicated RA preamble. The gNB transmits the RAR on PDSCH addressed to RA-RNTI. The RAR conveys RA preamble identifier and timing alignment information. The RAR may also include UL grant. RAR is transmitted in RAR window similar to contention based RA (CBRA) procedure.

The CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

2 Step Contention Based Random Access (2 Step CBRA)—In the first step, the UE transmits random access preamble on PRACH and a payload (i.e. MAC PDU) on PUSCH. The random access preamble and payload transmission is also referred as MsgA. In the second step, after MsgA transmission, the UE monitors for a response from the network (i.e. gNB) within a configured window. The response is also referred as/MsgB. If CCCH SDU was transmitted in MsgA payload, the UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include fallback information corresponding to the random access preamble transmitted in MsgA.

If the fallback information is received, the UE transmits Msg3 and performs contention resolution using Msg4 as in CBRA procedure. If contention resolution is successful, random access procedure is considered successfully completed. If the contention resolution fails upon fallback (i.e. upon transmitting Msg3), the UE re-transmits MsgA. If configured window in which the UE monitor network response after transmitting MsgA expires and UE has not received MsgB including contention resolution information or fallback information as explained above, the UE retransmits MsgA. If the random access procedure is not successfully completed even after transmitting the msgA configurable number of times, the UE fallbacks to 4 step RACH procedure i.e. UE only transmits the PRACH preamble.

2 Step Contention Free Random Access (2 Step CFRA): The gNB assigns to the UE dedicated Random access preamble(s) and PUSCH resource(s) for MsgA transmission. RACH Occasions RO(s) to be used for preamble transmission may also be indicated. In the first step, the UE transmits random access preamble on PRACH and a payload on PUSCH using the contention free random access resources (i.e. dedicated preamble/PUSCH resource/RO). In the second step, after MsgA transmission, the UE monitors for a response from the network (i.e. gNB) within a configured window. If the UE receives PDCCH addressed to C-RNTI, random access procedure is considered successfully completed. If the UE receives fallback information corresponding to its transmitted preamble, random access procedure is considered successfully completed.

Random Access Enhancements in NR Release 17: NR release 17 further enhances the RACH for various features like slicing, small data transmission (SDT), reduced capability UEs, coverage enhancements (msg3 repetitions) etc. A number of preambles from available RACH preambles and a number of RACH OCCASSIONS (RO) may be partitioned for various features. The gNB may also allocate different available RACH occasions to different features as indicated in the system information. For slicing, different slices or slice groups may be allocated different RACH resources. For SDT, there could be separate preamble groups based on the size of data to be transmitted. For coverage enhancements, the UE may be configured to repeat the msg3. For REDCAP, the msg1 resources allocated could be used to identify that the device is a reduced capability device. In addition, for each feature, a number of RACH parameters which can be configured separately.

Extracts from 3gpp TS 38.331 v17 which defines feature groups and its characteristics is given below.

FeatureCombination: The Information Element (IE) FeatureCombination indicates a feature or a combination of features to be associated with a set of Random Access resources (i.e. an instance of FeatureCombinationPreambles).

### FeatureCombination Information Element

-- ASNISTART
-- TAG-FEATURECOMBINATION-START
FeatureCombination-r17 ::= SEQUENCE {

| redCap-r17ENUMERATED {true} | | OPTIONAL, -- Need R |
|---|---|---|
| smallData-r17ENUMERATED {true} | | OPTIONAL, -- Need R |
| sliceGroup-r17 | SliceGroupList-r17 | OPTIONAL, -- Need R |

| | |
|---|---|
| msg3-Repetitions-r17ENUMERATED {true} | OPTIONAL, -- Need R |

| | | |
|---|---|---|
| spare4 | ENUMERATED | {true} |

OPTIONAL, -- Need R

| | | |
|---|---|---|
| spare3 | ENUMERATED | {true} |

OPTIONAL, -- Need R

| | | |
|---|---|---|
| spare2 | ENUMERATED | {true} |

OPTIONAL, -- Need R

| | | |
|---|---|---|
| spare1 | ENUMERATED | {true} |

OPTIONAL-- Need R
}
SliceGroupList-r17 ::= SEQUENCE (SIZE (1..ffsUpperLimit)) OF SliceGroupID-r17
-- TAG-FEATURECOMBINATION-STOP
-- ASNISTOP

FeatureCombinationIndication field descriptions

redCap
If present, this field indicates that RedCap is part of this feature
combination.
smallData
If present, this field indicates that Small Data is part of this feature
combination.
sliceGroup
If present, this field indicates slice group(s) that are part of this feature
combination.
msg3-Repetitions
If present, this field indicates that signalling of msg3 repetition is part
of this feature combination. This field is not configured in a set of
preambles that is configured with 2-step random-access type.

FeatureCombinationPreambles—The IEFeatureCombinationPreamblesassociates a set of preambles with a feature combination. For parameters which can be provided in the IE, the UE applies the field value when performing Random Access using a preamble in a featureCombinationPreambles, otherwise the UE applies the corresponding value as determined by applicable Need Code, e.g. Need S. On a specific BandWidthPart (BWP), there can be at most one set of preambles associated with a given feature combination per RA Type (i.e. 4-step RACH or 2-step RACH).

### FeatureCombinationPreamblesinformation Element

-- ASNISTART
-- TAG-FEATURECOMBINATIONPREAMBLES-START

| FeatureCombinationPreambles-r17 ::= | SEQUENCE { | |
|---|---|---|
| featureCombination-r17 | , | |
| startPreambleForThisPartition-r17 | INTEGER (1..64), | |
| numberOfPreamblesPerSSB-ForThisPartition-r17 | INTEGER (1..64), | |
| ssb-SharedRO-MaskIndex-r17 | INTEGER (1..15) | OPTIONAL, |
| -- Need S | | |
| groupBconfigured-r17SEQUENCE { | | |
| ra-SizeGroupA-r17 | ENUMERATED {b56, b144, b208, b256, b282, b480, b640, | |
| | b800, b1000, b72, spare6, spare5,spare4, spare3, spare2, | |
| spare1}, | | |
| messagePowerOffsetGroupB | ENUMERATED { minusinfinity, dB0, dB5, dB8, dB10, | |
| dB12, dB15, dB18}, | | |
| numberOfRA-PreamblesGroupA | INTEGER (1..64) | |
| }OPTIONAL, -- Need S | | |
| separateMsgA-PUSCH-Config-r17 | MsgA-PUSCH-Config-r16 | |
| OPTIONAL, -- Cond MsgAConfigCommon | | |
| msgA-RSRP-Threshold-r17 | RSRP-Range | |
| | OPTIONAL, -- Need R | |
| rsrp-ThresholdSSB-r17 | RSRP-Range | OPTIONAL, -- |
| Need R | | |
| deltaPreamble-r17 | INTEGER (−1.. ) | OPTIONAL,-- Need |

R
...
}
-- TAG-FEATURECOMBINATIONPREAMBLES-STOP
-- ASNISTOP

### Below Table Shows the FeatureCombinationPreamblesfield Descriptions

FeatureCombinationPreamblesfield descriptions
deltaPreamble
Power offset between msg3 or msgA-PUSCH and RACH preamble
transmission. If configured, this parameter overrides msg3-
DeltaPreamble or msgA-DeltaPreamble, Actual value = field value *
2 [dB] (see TS 38.213, clause 7.1). If msgA-DeltaPreamble is
configured in separateMsgA-PUSCH-Config-r17, this field is absent.
featureCombination
Indicates which combination of features that the preambles indicated
by this IE are associated with. The UE ignores a RACH resource
defined by this FeatureCombinationPreamblesif any feature within
the featureCombinationis not supported by the UE or has an unknown
value.
messagePowerOffsetGroupB
Threshold for preamble selection. Value is in dB. Value minusinfinity
corresponds to −infinity. Value dB0 corresponds to 0 dB, dB5
corresponds to 5 dB and so on (see TS 38.321, clause 5.1.2).
msgA-RSRP-Threshold
The UE selects 2-step random access type to perform random access
based on this threshold (see TS 38.321, clause 5.1.1). This field is
only present if partition specific RSRP threshold for 2-step and 4-step
RA type is configured for the BWP. If configured, this parameter
overrides msgA-RSRP-Threshold-r16. If absent, the UE applies
msgA-RSRP-Threshold-r16, if configured
numberOfPreamblesForThisPartition
It determines how many consecutive preambles are associated to the
Feature Combination starting from the starting preamble(s) per SSB.
numberOfRA-PreamblesGroupA
It determines how many consecutive preambles per SSB are
associated to Group A starting from the starting preamble(s). The
remaining preambles associated to the Feature Combination are
associated to Group B
ra-SizeGroupA
Transport Blocks size threshold in bits below which the UE shall use
a contention-based RA preamble of group A. (see TS 38.321, clause
5.1.2). If this feature combination preambles are associated to a
RACH-ConfigCommon-twostepRA, this field correspond to ra-
MsgA-SizeGroupA, otherwise it corresponds to ra-Msg3SizeGroupA.
rsrp-ThresholdSSB
L1-RSRP threshold used for determining whether a candidate beam
may be used by the UE. If this parameter is included in
FeatureCombinationPreambles which is included in RACH-
ConfigCommonTwoStepRA, it corresponds to msgA-RSRP-
ThresholdSSB, as defined in TS 38.321. If this parameter is included
in FeatureCombinationPreambles which is included in RACH-
ConfigCommon, it corresponds to rsrp-ThresholdSSB, as defined in
TS 38.321.
separateMsgA-PUSCH-Config
If present it specifies how the 2-step RACH preambles identified by
this FeatureCombinationPreambles are mapped to a PUSCH slot
separate from the one defined in MsgA-ConfigCommon-r16. If the
field is absent, the UE should apply the corresponding parameter in
the RACH-ConfigCommonTwoStepRAof the BWP which includes
theFeatureCombinationPreambles IE.
ssb-SharedRO-MaskIndex
Mask index (see 38.321).
Indicates a subset of ROs where preambles are allocated for this
feature combination. If this field is configured within
FeatureCombinationPreambles which is included in RACH-
ConfigCommonTwoStepRA, it indicates a subset of ROs configured
within this RACH-ConfigCommonTwoStepRA. This field is
configured when there is more than one RO per SSB. If the field is
absent, all ROs configured in RACH-ConfigCommon or RACH-
ConfigCommonTwoStepRA containing this.
FeatureCombinationPreamblesare shared.
startPreambleForThisPartition
It defines the first preamble associated with the Feature Combination.
If N < 1 the first preamble in each PRACH occasion is the one having
the same index indicated by this field. If N >= 1 in each PRACH
occasion N blocks of preambles associated with the Feature
$Combination are define , each having start index n \cdot {N}_{preamble}^{total} / N +$
startPreambleForThisPartition (see 38.213).

Each of the features may be allocated a priority as specified below in TS 38.331 V17.0.0.

| featurePriorities-r17 | SEQUENCE { | |
|---|---|---|
| redCapPriority-r17 | FeaturePriority-r17 | OPTIONAL, |
| slicingPriority-r17 | FeaturePriority-r17 | OPTIONAL, |
| msg3-Repetitions-Priority-r17 | FeaturePriority-r17 | OPTIONAL, |
| sdt-Priority-r17 | FeaturePriority-r17 | OPTIONAL |

}
FeaturePriority-r17 ::= INTEGER (0..7)

| Conditional Presence | Explanation |
|---|---|
| MsgAConfigCommon | The field is optionally present, Need S, if |
| | FeatureCombinationPreambles is included |
| | in RACH-ConfigCommonTwoStepRA. |
| | Otherwise, it is absent. If the field is absent |
| | in FeatureCombinationPreambles included |
| | in RACH-ConfigCommonTwoStepRA, the |
| | UE applies MsgA-PUSCH-Config included |
| | in the corresponding MsgA- |
| | ConfigCommon. |

featurePriorities—Indicates priorities for features, such as RedCap, Slicing, S+DT and MSG3-Repetitions for Coverage Enhancements. These priorities are used to determine which FeatureCombinationPreambles the UE shall use when a feature maps to more than one FeatureCombinationPreambles, as specified in TS 38.321. A lower value means a higher priority. The network does not signal the same priority for more than one feature. The network signals a priority for all feature that map to at least one FeatureCombinationPreambles.

For different features, there may be a different criterion which decides whether UE can select the feature specific RACH resources. In general, the criteria is broadcasted by gNB or configured through RRC release message. For slicing, the criteria is based on the slice group (also known as NSAG) or slice-id that triggers the msg1 transmission. For coverage enhancements, the criteria may be based on the measured RSRP (Reference Signal Received Power) at the time of msg3 repetitions.

When feature specific RACH partitioning is used, UL BWP configuration can include additional RACH configuration as below from TS 38.331.

| | |
|---|---|
| BWP-UplinkCommon ::= | SEQUENCE { |
| genericParameters | BWP, |
| rach-ConfigCommon | SetupRelease { RACH-ConfigCommon } |
| OPTIONAL, -- Need M | |
| pusch-ConfigCommon | SetupRelease { PUSCH-ConfigCommon } |
| OPTIONAL, -- Need M | |
| pucch-ConfigCommon | SetupRelease { PUCCH-ConfigCommon } |
| OPTIONAL, -- Need M | |
| ..., | |
| [[ | |
| rach-ConfigCommonIAB-r16 | SetupRelease { RACH-ConfigCommon } |
| OPTIONAL, -- Need M | |
| useInterlacePUCCH-PUSCH-r16 | ENUMERATED {enabled} |
| OPTIONAL, -- Need R | |
| msgA-ConfigCommon-r16 | SetupRelease { MsgA-ConfigCommon-r16 } |
| OPTIONAL -- Cond SpCellOnly2 | |
| ]], | |
| [[ | |
| enableRA-PrioritizationForSlicing-r17 | BOOLEANOPTIONAL, -- Cond RAPrioSliceAI |
| additionalRACH-ConfigCommon-r17 | SEQUENCE (SIZE(0..maxAdditionalRACH-r17)) OF |
| AdditionalRACH-ConfigCommon-r17 | OPTIONAL -- Cond SpCellOnly3 |

]]
AdditionalRACH-ConfigCommon-r17 ::= SEQUENCE {

| | | |
|---|---|---|
| rach-ConfigCommon-r17 | RACH-ConfigCommon | OPTIONAL, |

| | |
|---|---|
| -- Need R | |
| msgA-ConfigCommon-r17 | MsgA-ConfigCommon-r16 |

OPTIONAL, -- Cond R
...
}

Self Optimisation in NR—the 5G NR radio access network also known as NG-RAN (Next Generation Radio Network) comprises of a number of NR base stations knows as gNBs. The gNBs can be connected to each other through Xn interface, and is connected to various core network elements like AMF (Access and Mobility Management Function), UPF (User Plane Function) etc. Further gNBs can be divided into two physical entities named CU (Centralized Unit) and DU (Distributed Unit). The CU provides support for the higher layers of the protocol stack such as SDAP (Session Data Application Protocol), PDCP (Packet Data Convergence Protocol) and RRC (Radio Resource Control) while DU provides support for the lower layers of the protocol stack such as RLC (Radio Link Control), MAC (Medium Access Control) and Physical layer. Each gNB can have multiple cells serving many UEs (User Equipment). There are a large number of algorithms and configuration parameters used in NG-RAN. Especially, it is a very difficult task to identify the most optimal radio parameters and operators used to resort to manual techniques like drive tests to identify the parameters.

However, such manual parameter tuning is a costly operation since the manual parameter depends on a lot of factors like the number of users, number of neighbors, maximum throughput in the cell, average throughput in the cell etc. Further, whenever a neighbor gNB is installed or a new service is introduced, many of these manual operations need to be repeated. To resolve the problem, 3gpp has introduced Self-Organizing Networks (SON) techniques in the wireless technologies like NR. SON was first introduced in 3gpp release 9, in LTE.SON solutions can be divided into three categories: Self-Configuration, Self-Optimization and Self-Healing. The SON architecture can be a centralized, distributed or a hybrid solution.

Self-optimization of RACH aims to minimize the number of attempts on the RACH. UE can report the detailed information about RACH in the RACH Report to the network and the network optimizes various parameters associated with RACH using the information. The List of information that the UE could report in RACH is given as below based on NR TS 38.331.

RA-ReportList-r16 ::=SEQUENCE(SIZE(1..maxRAReport-r16))OF RA-Report-r16
RA-Report-r16 ::=SEQUENCE {

| | |
|---|---|
| cellId-r16 | CHOICE { |
| cellGlobalId-r16 | CGI-Info-Logging-r16, |
| pci-arfen-r16 | SEQUENCE { |
| physCellId-r16 | PhysCellId, |
| carrierFreq-r16 | ARFCN-ValueNR |

```
    }
  },
ra-InformationCommon-r16RA-InformationCommon-r16OPTIONAL,
```

| | |
|---|---|
| raPurpose-r16 | ENUMERATED {accessRelated, beamFailureRecovery, |

reconfiguration WithSync, ulUnSynchronized,
schedulingRequestFailure, noPUCCHResourceAvailable, requestForOtherSI,

spare9, spare8, spare7, sparc6, spare5, spare4, spare3, spare2,

```
spare1},
  ...
}
RA-InformationCommon-r16 ::=SEQUENCE {
absoluteFrequencyPointA-r16ARFCN-ValueNR,
location AndBandwidth-r16INTEGER (0..37949),
subcarrierSpacing-r16SubcarrierSpacing,
msg1-FrequencyStart-r16INTEGER (0..maxNrofPhysicalResourceBlocks-1)OPTIONAL,
msg1-FrequencyStartCFRA-r16INTEGER (0..maxNrofPhysicalResourceBlocks-1)OPTIONAL,
msg1-SubcarrierSpacing-r16SubcarrierSpacingOPTIONAL,
msg1-SubcarrierSpacingCFRA-r16SubcarrierSpacingOPTIONAL,
msg1-FDM-r16ENUMERATED {one, two, four, eight}OPTIONAL,
msg1-FDMCFRA-r16ENUMERATED {one, two, four, eight}OPTIONAL,
perRAInfoList-r16PerRAInfoList-r16,
...,
[[
perRAInfoListExt-v1660PerRAInfoListExt-v1660OPTIONAL
        ]],
    [[
```

| | |
|---|---|
| msgA-FrequencyStart-r17 | INTEGER (0..maxNrofPhysicalResourceBlocks-1) |

OPTIONAL,

| | |
|---|---|
| msgA-FrequencyStartCFRA-r17 | INTEGER (0..maxNrofPhysicalResourceBlocks-1) |

OPTIONAL,

| | |
|---|---|
| msgA-SubcarrierSpacing-r17 | SubcarrierSpacingOPTIONAL, |
| msgA-SubcarrierSpacingCFRA-r17 | SubcarrierSpacingOPTIONAL, |
| msgA-FDM-r17 | ENUMERATED {one, two, four, eight} OPTIONAL, |
| msgA-FDMCFRA-r17 | ENUMERATED {one, two, four, eight; OPTIONAL, |
| measuredDL-RSRP-r17 | RSRP-RangeOPTIONAL, |

msgA-TransMax-r17ENUMERATED {n1, n2, n4, n6, n8, n10, n20, n50, n100, n200}
OPTIONAL

| | | |
|---|---|---|
| msgA-MCS-r17 | INTEGER (0.. 5) | OPTIONAL, |
| nrofPRBs-PerMsgA-PO-r17 | INTEGER (1..32) | OPTIONAL, |

| | |
|---|---|
| msgA-PUSCH-TimeDomainAllocation-r17 | INTEGER (1..maxNrofUL-Allocations) |

OPTIONAL,

| | |
|---|---|
| frequencyStartMsgA-PUSCH-r17 | INTEGER (0..maxNrofPhysicalResourceBlocks-1) |

OPTIONAL,

| | | |
|---|---|---|
| nrofMsgA-PO-FDM-r17 | ENUMERATED {one, two, four, eight} | OPTIONAL, |

dlPathlossRSRP-r17RSRP-RangeOPTIONAL,

| | |
|---|---|
| intendedSIBs-r17SEQUENCE (SIZE (1..maxSIB)) OF SIB-Type-r17 | OPTIONAL, |

| | |
|---|---|
| ssbsForSI-Acquisition-r17 | SEQUENCE(SIZE (1..maxNrofSSBs-r16)) OF SSB-Index |

OPTIONAL,

| | |
|---|---|
| msgA-PUSCH-PayloadSize-r17 | BITSTRING (SIZE (3))OPTIONAL, |
| onDemandSISuccess-r17 | BOOLEANOPTIONAL |

]]
}
PerRAInfoList-r16 ::=SEQUENCE(SIZE(1..200))OFPerRAInfo-r16
PerRAInfoListExt-v1660 ::=SEQUENCE (SIZE (1..200)) OF PerRACSI-RSInfoExt-v1660
PerRAInfo-r16 ::=CHOICE {
perRASSBInfoList-r16PerRASSBInfo-r16,
perRACSI-RSInfoList-r16PerRACSI-RSInfo-r16
}
PerRASSBInfo-r16 ::=SEQUENCE{
ssb-Index-r16SSB-Index,
numberOfPreamblesSentOnSSB-r16INTEGER (1..200),
perRAAttemptInfoList-r16
}
PerRACSI-RSInfo-r16 ::=SEQUENCE{

| | |
|---|---|
| csi-RS-Index-r16 | CSI-RS-Index, |

numberOfPreamblesSentOnCSI-RS-r16INTEGER (1..200)
}
PerRACSI-RSInfoExt-v1660 ::=SEQUENCE {

| | | |
|---|---|---|
| csi-RS-Index-v1660 | INTEGER (1..96) | OPTIONAL |

}
PerRAAttemptInfoList-r16 ::=SEQUENCE (SIZE (1..200)) OF PerRAAttemptInfo-r16
PerRAAttemptInfo-r16 ::=SEQUENCE {

| | |
|---|---|
| contentionDetected-r16 | BOOLEANOPTIONAL, |
| dIRSRPAboveThreshold-r16 | BOOLEANOPTIONAL, |

```
  ...,
[[
fallbackRAR-Received-r17BOOLEANOPTIONAL
    ]]
}
```

The UE sends RACH reports to the network in RRC messages, for e.g. UE Information Response. On receiving the RACH report, the gNB CU may send the RACH reports to the gNB DU or Operations, Administration, and Maintenance Self Organizing Networks (OAM SON) module or may directly use the RACH reports for optimizing various parameters related to random access. For e.g. the number of preambles, configuration of group A and group B preambles, RACH prioritization information, contention resolution timer, number of RACH preambles for 2 step RACH, PUSCH related parameters for 2 step RACH etc.

It is desired to address the above mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiment herein is to provide a method for self-optimization of RACH in a wireless network. The method includes detecting, by a UE, a network event in the wireless network. Further, the method includes storing, by the UE, a feature specific RACH information corresponding to a feature specific RACH applied by the UE for one of multiple features of a plurality of features and a specific feature of the plurality of features. The plurality of features includes a SDT, coverage enhancement (i.e., msg3 repetition), a Redcap and network slicing. Further, the method includes receiving, by the UE, an information request message from a network apparatus. Further, the method includes including, by the UE, the feature specific RACH information corresponding to the feature specific RACH applied by the UE for one of the multiple features and the specific feature in an information response message for self-optimization of the RACH. Further, the method includes sending, by the UE, the information response message includes the feature specific RACH information corresponding to the feature specific RACH applied by the UE to the network apparatus in the wireless network.

The proposed methods provides that a UE logs and reports various details of the features which are applied for feature specific random access like the feature identifiers and priorities, NSAG related information like NSAG identifiers and NSAG priorities, msg3 repetition related information like the number of msg3 repetitions and the used MCS to the network for self-optimisation purposes.

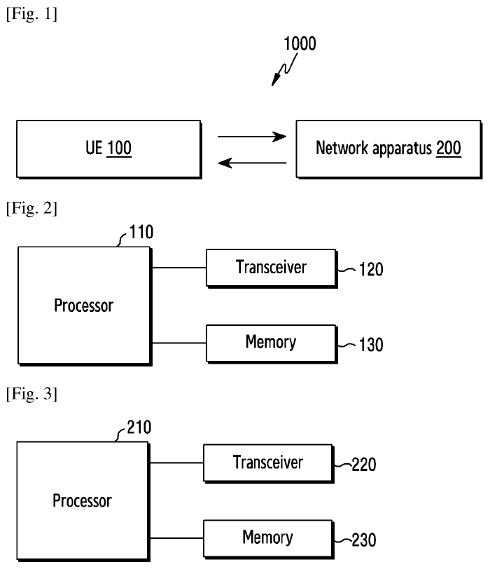

FIG. 1 illustrates an overview of a wireless network (1000) for self-optimization of RACH, according to the embodiments as disclosed herein. In an embodiment, the wireless network (1000) includes a UE (100) and a network apparatus (200). The wireless network (1000) can be, for example, but not limited to a fourth generation (4G) network, a fifth generation (5G) network, an Open Radio Access Network (ORAN) or the like. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a base station (e.g, gNB, eNB, new radio (NR) trans-receiver or the like). And as used herein, network apparatus, base station, eNB, or gNB may refer to the network apparatus (200).

The UE (100) detects a network event in the wireless network (1000). Upon

detecting the network event, the UE (100) stores a feature specific RACH information corresponding to a feature specific RACH applied by the UE (100) for one of multiple features of a plurality of features and a specific feature of the plurality of features. The plurality of features includes a SDT, coverage enhancement (i.e., msg3 repetition), a Redcap, and network slicing. Further, the UE (100) receives an information request message from a network apparatus (200). Further, the UE (100) includes the feature specific RACH information corresponding to the feature specific RACH applied by the UE (100) for one of the multiple features and the specific feature in an information response message for self-optimization of the RACH. Further, the UE (100) sends the information response message comprising the feature specific RACH information corresponding to the feature specific RACH applied by the UE (100) to the network apparatus (200).

In an embodiment, the feature specific RACH information corresponding to the feature specific RACH applied by the UE (100) for the multiple features includes a list of features for which the feature specific RACH is applied, a priority associated with each feature in the list of features. The priority is provided by at least one of explicitly logging and reporting a feature priority received from the network apparatus (200) and by implicitly providing a relative priority by logging and reporting the features in a priority order, and at least one parameter received in an additional RACH configuration. The parameter received in the additional RACH configuration is zero or more parameters depending on the configuration. The parameter from the additional RACH configuration include msg1-SCS-From-prach-ConfigurationIndex, msg1-SubcarrierSpacing-r16 etc.

In an embodiment, the feature specific RACH information corresponding to the feature specific RACH applied by the UE (100) for the multiple features includes at least one parameter received in a Feature Combination Preamble. The at least one parameter includes at least one of a msgA-MCS, nrofPRBs-PerMsgA-PO, msgA-PUSCH-TimeDomainAllocation, frequencyStartMsgA-PUSCH, nrofMsgA-PO-FDM and msgA-SubcarrierSpacing.

In an embodiment, the feature specific RACH information corresponding to the feature specific RACH applied by the UE (100) for the specific feature related to the network slicing includes a list of all Network Slice AS groups (NSAGs) that are used/applied for the feature specific random access at the UE (100) and NSAG priority of the NSAGs as received from a core network.

In an embodiment, the feature specific RACH information includes whether the UE (100) has used MPS or MCS specific RACH prioritization, whether the UE (100) has used slicing based RACH prioritization for random access, and a scaling Factor BI for the network slicing or MPS or MCS, power ramping step high priority for the MPS or MCS, power ramping step high priority for the NSAG used for selecting the feature specific RACH related to the network slicing, whether there is a collision between MPS or MCS and NSAG based RACH, scalingFactorBI for the NSAG used for selecting slice based RACH, powerRampingStepHighPriority for the NSAG used for selecting slice based RACH, scalingFactorBI for MPS/MCS and powerRamping-StepHighPriority for MPS/MCS.

In an embodiment, the feature specific RACH information corresponding to the feature specific RACH applied by the UE (100) for the specific feature related to the msg3 repetition includes a number of msg3 repetitions performed, and a number of msg3 repetitions requested by the network apparatus (200) to be performed, and a MCS used for the msg3 repetitions, and information about whether the msg3 repetitions terminated based on Layer 1 inputs.

In an example, the UE (100) which has initiated random access applying feature specific RACH logs and reports various information for the SON for optimizing RACH to a gNB as given the patent disclosure.

If the random access was attempted by applying feature specific RACH, the UE (100) logs and reports the list of the features that were applicable for the random access and informs the gNB. The features could be the slicing (or slice group/NSAG), the SDT, the Redcap, the msg3 repetition etc. The UE (100) can log and report the information in Information Elements (IEs) like RA Report. The UE (100) also may store in the UE variables such as VarRA_Report in the NR.

In an embodiment, when the UE (100) has not initiated random access by applying feature specific RACH since feature specific RACH configuration or partitioning were not available even when the conditions for triggering feature specific RACH was not satisfied and so on, the UE (100) logs and reports list of the features. That is, the UE (100) logs the features that have triggered the random access.

In an embodiment, when multiple features are applicable for the random access, the applicable features are logged/listed in the priority order in the RA Report and reported. The priority order can be ascending order or descending order. The UE (100) also logs and reports the feature priority of applicable features.

When the feature specific RACH is used and the RACH configuration from additional configuration (e.g. AdditionalRACH-ConfigCommon) is applied, the UE (100) logs and reports the AdditionalRACH-ConfigCommon or the IEs from AdditionalRACH-ConfigCommon received from the gNB instead of the RACH-ConfigCommon or IEs from RACH-ConfigCommon.

The UE (100) sets RA-InformationConfigCommon in the RA-Report based on the AdditionalRACH-ConfigCommon when the AdditionalRACH-ConfigCommon is used for the feature specific random access rather than RACH-ConfigCommon for a normal RACH.

In an embodiment, the UE (100) sets the IE's IE in a RA-InformationCommon-r16 in the RA-Report as per the AdditionalRACH-ConfigCommon that is used for the feature specific RACH.

In an embodiment, the UE (100) logs and reports one or more of the information elements received in FeatureCombinationPreambles in the RRC message and logs and reports to the network for RACH SON. The information elements or parameters logged and reported by selecting the information from the FeatureCombinationPreambles includes msgA-MCS, nrofPRBs-PerMsgA-PO, msgA-PUSCH-TimeDomainAllocation, frequencyStartMsgA-PUSCH, nrofMsgA-PO-FDM and msgA-SubcarrierSpacing. The FeatureCombinationPreamble is the FeatureCombinationPreamble corresponding to the combination of features used by the UE for performing this random access.

In an embodiment, the network apparatus (e.g., gNB or the like) configures the UE (100) to log and report the information about feature specific RACH. The UE (100) logs and reports the features specific RACH related information if the UE (100) is configured to do so. This may be separate from the configuration for the RACH report. The gNB may also indicate which features for which UE (100) needs to log and report the details in the RACH report and the UE (100) reports the details based on gNB indication.

In an embodiment, the feature specific information may be reported for each RACH attempt, for e.g. in PerRAAttemptInfo-r16. In another embodiment, the feature specific information may be reported for all the random access attempts in the RA-InformationCommon-r16 or a PerRAInfo-r16.

In an embodiment, if there is a fallback from the feature specific RACH to the common RACH both AdditionalRACH-ConfigCommon or the IEs from AdditionalRACH-ConfigCommon and the RACH-ConfigCommon or IEs from RACH-ConfigCommon are logged and reported by the UE (100). The UE (100) may also log and report whether there is a fallback to common RACH (for instance 4 step) from feature specific RACH (for e.g. 2 step). The UE (100) logs and reports additional RACH common configuration (AdditionalRACH-ConfigCommon) and RACH common configuration (RACH-ConfigCommon) when the RA Report include some random access attempts that use RACH-ConfigCommon and some access attempts that use RACH-ConfigCommon.

In an embodiment, a cause value indicates within raPurpose-r16 in RA Report indicates that the random access is for feature specific RACH. The cause value may indicate the applicable feature also.

If the RACH access is performed based on slicing, i.e. based on the Network Slice AS group (NSAG) that is part of feature combination, the UE (100) logs and reports the following additional information for the SON and reports to the network, for e.g. in RACH report.
i. The UE (100) logs and reports a nsag-identity (including nsag id and TAC), a NSAG priority and the feature priority of the NSAG used for selecting slice based RACH. The UE (100) may log and report the list of all the NSAGs that were available at the UE (100) (i.e. configured by Non Access Stratum) and their priorities. The UE (100) logs and reports the NSSAI of all the applicable slices along with the NSAG id.
ii. The UE (100) logs and reports the scalingFactorBI and powerRampingStepHighPriority for the NSAG used for selecting slice based RACH. UE may indicate that the UE used scalingfactorBI for slicing or MPS/MCS.

The UE (100) logs and reports the flag which indicates whether the UE (100) used slicing specific or MPS/MCS specific RACH parameters like scalingFactorBI and powerRampingStepHighPriority. The UE (100) may specifically log and report the type of RACH prioritization parameters used (Slicegroup or MPS/MCS) using an enumeration. In an embodiment, the UE (100) logs and reports the information if/when there is a collision between MPS/MCS and slicegroup feature. (i.e. both the features may be applicable for RACH at the same time for e.g. when both the provided slice group identity and the provided Access Identity whose corresponding bit in the ra-PrioritizationForAI is set to one are configured with ra-Prioritization either in RACH-ConfigCommon or RACH-ConfigCommonTwoStepRA).

The UE (100) logs and reports the received information elements such as enableRA-PrioritizationForSlicing for the UL BWP where RACH access is performed (Network indication of whether NSAG overrides MPS/MCS or MPS/MCS overrides NSAG).

The UE (100) logs and reports whether there is a collision between MPS/MCS and NSAG based RACH (i.e. whether both are applicable for a RACH or a RACH attempt). In an embodiment, the UE (100) logs and reports the flag which indicates whether a prioritization between MPS/MCS and NSAG based RACH was done (RACH parameters are selected based on some prioritization due to the collision). The UE (100) may also log and report whether the UE (100) has selected MPS/MCS based RACH prioritisation or NSAG based RACH prioritization. That is, whether the UE (100) has used RACH parameters like scalingFactorBI and powerRampingStepHighPriority based on MPS/MCS or slicegroup during a collision (when both MPS/MCS and slicegroup are applicable). When there is no collision, the UE (100) may skip logging and reporting the information. In an embodiment, the UE (100) skips logging and reporting the information if there is only one RACH attempt logged in the RA Report, (or when the scalingFactorBI and powerRampingStepHighPriority are not used for the random access attempts in the RA report)

In an additional embodiment, when both MPS/MCS and another feature like redcap or msg3 repetition,SDT are applicable, the UE (100) logs and reports whether the UE (100) has used RACH parameters based on MPS/MCS or those features.

If the feature is msg3 repetition (i.e. coverage enhancement or msg3 repetition for coverage enhancement), the UE (100) logs and reports to the gNB that random access was attempted applying feature specific RACH for mg3 repetition (mg3 repetition for coverage enhancement). Further, the UE (100) logs and reports the number of group A/group-B msg3 transmissions performed during RACH procedure to the gNB. The UE (100) also logs and reports the number of group-A/group-B msg3 transmissions asked to be performed by the gNB, for e.g. via the DCI (along with some configuration in RRC Reconfiguration).In an option, the UE (100) may just log and send the code point received in DCI (00,01,02,03).

In an embodiment, the UE (100) may not log and report the details of msg3 repetition if the 2 step RACH is used. But if there is a fallback to 4 step RACH from 2 step RACH, msg3 repetition related information may be logged and reported.

In an embodiment, the UE (100) logs and reports the MCS used for msg3 repetition. Alternately, the UE (100) logs and reports the information received from the gNB in the DCI (code point) for the MCS to be used for msg3 repetitions.

In an embodiment, the UE (100) logs and reports whether msg3 repetition was terminated by lower layer inputs. In other words, the UE (100) logs whether msg3 was repeated the number of times gNB has indicated in DCI (along with RRC configuration) etc. In an option, this may be a flag. Alternatively, this may be an integer which indicates the number of times the msg3 transmission was skipped due to lower layer inputs. Lower layer means layer1 here and the layer that repeats msg3 is layer 2 (MAC). For e.g. the gNB may pre-empt msg3 transmission for other higher priority transmissions and the msg3 repetition may not be completed.

The UE (100) may log both the number of times the msg3 was transmitted and the number of times msg3 repetition was requested (scheduled) through DCI or other means like pre-configuration, and gNB identifies that the msg3 repetition was terminated based on these inputs.

Here mentioned sections are applicable for all the above cases.

Typically, the details will be send using RRC messages like RRC UE Information Response and the information elements like ra-InformationCommon in RA Report, RLF (radio link failure) Report or part of ra-InformationCommon in CEF (connection establishment failure) report, though other messages or IEs (information elements) are not precluded.

In an option, the UE (100) may set all the information after the successful completion of random access procedure or during the detection of radio link failure (RLF) or during the connection establishment failure like expiry of timers T300 or T319 during RRC procedures like RRC connection establishment or RRC connection resume in var-RAReport, var-RLFReport, var-CEFReport etc. Further, the UE (100) sends the UE information response with RA report/RLF report/CEF report on receiving RRC message UE information Request with the ra-ReportReq/rlf-reportReq/connestFailReportReq set to true. The UE (100) may also include these information in a Successful Handover Report (SHR) or a Successful PSCellChange and Successful PSCell Addition Report (SPR).

On receiving the RRC message including the details of feature specific random access resource selection, a gNB RRC in a gNB Centralized Unit (CU) may forward the RRC message to the gNB DU and to the SON module, for e.g. OAM. The SON module in a Centralized Unit/Distributed Unit (CU/DU) or SON module outside gNB can identify if the amount of resources allocated for a particular feature or a particular scenario within the feature (for e.g. resources for a particular slice-group) is optimum based on the received information.

Further, the resources allocated per feature or per slice-group could be increased or decreased based on the received information. Self optimisation module in the network may also adapt the criteria for using the feature specific random access resources and other RACH parameters based on the received information from the UE (100). Examples of some of the parameters which may be optimized based on the methods specified are given below.
a) SSB selection related parameters, i.e., rsrp-ThresholdSSB, msgA-RSRP-ThresholdSSB.
b) Power control related parameters, i.e., preambleReceivedTargetPower/gA-PreambleReceivedTargetPower, powerRampingStep/msgA-PreamblePowerRampingStep, msg3-DeltaPreamble/msgA-DeltaPreamble
c) Preamble group related parameters, i.e.,

msg3-DeltaPreamble/msgA-DeltaPreamble, messagePowerOffsetGroupB for 2-step RA and 4-step RA.
d) ra-Msg3SizeGroupA, messagePowerOffsetGroupB and numberOfRA-PreamblesGroupA when Preamble Group B, msg3 repetitions etc.
e) Slicegroup or msg3 repetition specific parameters like scalingFactorBI and power-RampingStepHighPriority for slicing or enableRA-PrioritizationForSlicing

FIG. 2 shows various hardware components of the UE (100), according to the embodiments as disclosed herein. In an embodiment, the UE (100) includes a processor (110), a communicator or transceiver (120) and a memory (130). And the UE (100) may further include a feature specific RACH controller. The processor (110) is coupled with the transceiver (120), the memory (130) and the feature specific RACH controller. The feature specific RACH controller may be included in the processor (110) or may be located separately from the processor (110). Also, the processor (110) may perform the operation of the feature specific RACH controller. However, the components of the UE (100) are not limited thereto. For example, the UE (100) may include more or fewer components than those described above. In addition, the processor (110), the transceiver (120), and the memory (130) may be implemented as a single chip. Also, the processor (110) may include at least one processor.

The feature specific RACH controller detects the network event in the wireless network (1000). Upon detecting the network event, the feature specific RACH controller stores the feature specific RACH information corresponding to the feature specific RACH applied by the UE (100) for one of multiple features of the plurality of features and the specific feature of the plurality of features. The plurality of features includes the SDT, the coverage enhancement (i.e., msg3 repetition), the Redcap, and the network slicing. Further, the feature specific RACH controller receives the information request message from the network apparatus. Further, the feature specific RACH controller includes the feature specific RACH information corresponding to the feature specific RACH applied by the UE (100) for one of the multiple features and the specific feature in the information response message for the self-optimization of the RACH. Further, the feature specific RACH controller sends the information response message comprising the feature specific RACH information corresponding to the feature specific RACH applied by the UE (100) to the network apparatus in the wireless network (1000).

The feature specific RACH controller is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) is configured to execute instructions stored in the memory (130) and to perform various processes. The processor (110) may control a series of processes such that the UE (100) operates as described above. For example, the transceiver (120) may receive a data signal including a control signal transmitted by the base station or the network entity, and the processor (110) may determine a result of receiving the control signal and the data signal transmitted by the base station or the network entity.

The transceiver (120) is configured for communicating internally between internal hardware components and with external devices via one or more networks. The transceiver (120) collectively refers to a UE (100) receiver and a UE (100) transmitter, and may transmit/receive a signal to/from a base station or a network entity. The signal transmitted or received to or from the base station or a network entity may include control information and data. The transceiver (120) may include a RF transmitter for up-converting and amplifying a frequency of a transmitted signal, and a RF receiver for amplifying low-noise and down-converting a frequency of a received signal. However, this is only an example of the transceiver 220 and components of the transceiver (120) are not limited to the RF transmitter and the RF receiver. Also, the transceiver (120) may receive and output, to the processor (110), a signal through a wireless channel, and transmit a signal output from the processor (110) through the wireless channel.

The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function in the UE (100).

FIG. 3 shows various hardware components of the base station, according to the embodiments as disclosed herein. In an embodiment, the base station includes a processor (210), a communicator or transceiver (220), a memory (230) and a feature specific RACH controller. The processor (210) is coupled with the transceiver (220), the memory (230) and the feature specific RACH controller. The feature specific RACH controller may be included in the processor (210) or may be located separately from the processor (210). Also, the processor (210) may perform the operation of the feature specific RACH controller. However, the components of the base station are not limited thereto. For example, the base station may include more or fewer components than those described above. In addition, the processor (210), the transceiver (220), and the memory (230) may be implemented as a single chip. Also, the processor (210) may include at least one processor.

The feature specific RACH controller sends the information request message to the UE (100) in the wireless network (1000). Further, the feature specific RACH controller receives the information response message comprising the feature specific RACH information corresponding to the feature specific RACH applied by the UE (100) for one of multiple features of the plurality of features and the specific feature of the plurality of features from the UE (100). The plurality of features includes the SDT, the coverage enhancement (i.e., msg3 repetition), the Redcap, and network slicing. Further, the feature specific RACH controller optimizes the network parameter related to the RA based on the feature specific RACH information received from the UE (100) and the criteria for using the feature specific RACH.

The feature specific RACH controller is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) is configured to execute instructions stored in the memory (230) and to perform various processes. The processor (210) may control a series of processes such that the base station operates as described above. For example, the transceiver (220) may receive a data signal including a control signal transmitted by the terminal, and the processor (210) may determine a result of receiving the control signal and the data signal transmitted by the terminal.

The transceiver (220) is configured for communicating internally between internal hardware components and with external devices via one or more networks. The transceiver (220) collectively refers to a base station receiver and a base station transmitter, and may transmit/receive a signal to/from a terminal (UE) or a network entity. The signal transmitted or received to or from the terminal or a network entity may include control information and data. The transceiver (220) may include a RF transmitter for up-converting and amplifying a frequency of a transmitted signal, and a RF receiver for amplifying low-noise and down-converting a frequency of a received signal. However, this is only an example of the transceiver (220) and components of the transceiver (220) are not limited to the RF transmitter and the RF receiver. Also, the transceiver (220) may receive and output, to the processor (210), a signal through a wireless channel, and transmit a signal output from the processor (210) through the wireless channel.

The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the base station but it is to be understood that other embodiments are not limited thereon. In other embodiments, the base station may include less or more number of components. Further, the labels or names of the components are used only for illustrative purpose and does not limit the scope of the disclosure. One or more components can be combined together to perform same or substantially similar function in the base station.

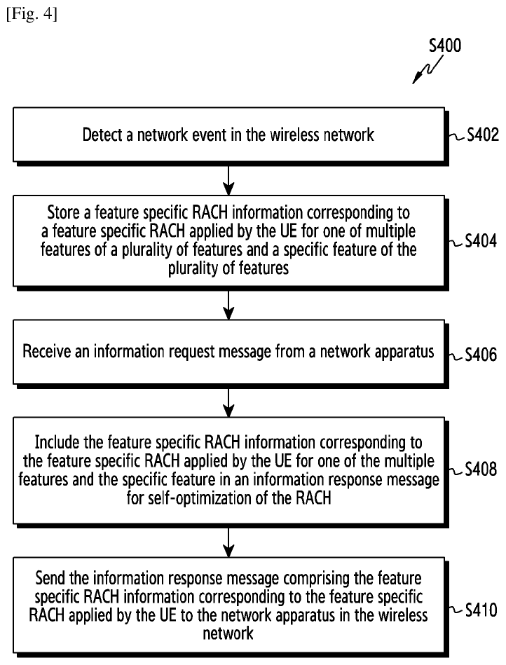

FIG. 4 is a flow chart (S400) illustrating a method, implemented by the UE (100), for self-optimization of RACH in the wireless network (1000), according to the embodiments as disclosed herein. The operations (S402-S410) are handled by the feature specific RACH controller.

At step S402, the method includes detecting the network event in the wireless network (1000). At step S404, the method includes storing the feature specific RACH information corresponding to the feature specific RACH applied by the UE (100) for one of multiple features of a plurality of features and a specific feature of the plurality of features. The plurality of features includes the SDT, the coverage enhancement (i.e., msg3 repetition), the Redcap, and the network slicing. At step S406, the method includes receiving the information request message from the base station. At step S408, the method includes including the feature specific RACH information corresponding to the feature specific RACH applied by the UE (100) for one of the multiple features and the specific feature in an information response message for self-optimization of the RACH. At step S410, the method includes sending the information response message includes the feature specific RACH information corresponding to the feature specific RACH applied by the UE (100) to the base station in the wireless network (1000).

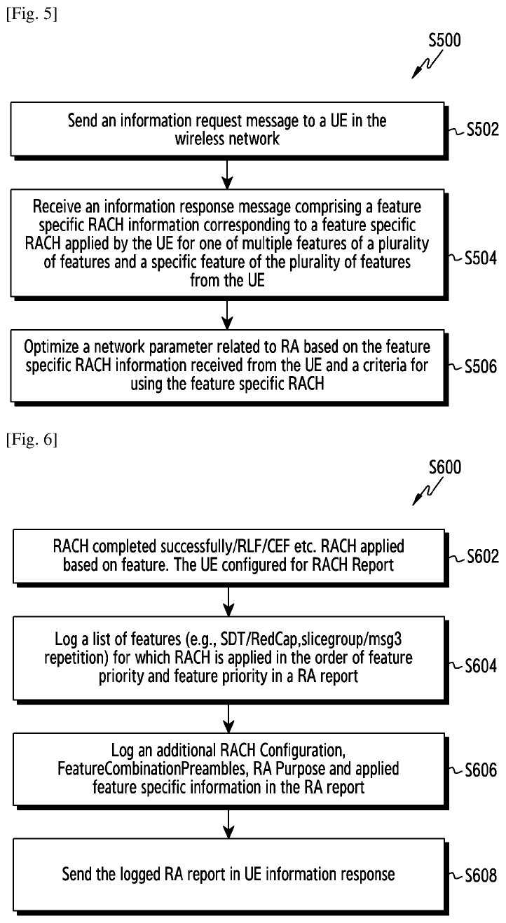

FIG. 5 is a flow chart (S500) illustrating a method, implemented by the base station, for self-optimization of RACH in the wireless network (1000), according to the embodiments as disclosed herein. The operations (S502-S506) are handled by the feature specific RACH controller.

At step S502, the method includes sending the information request message to the UE (100) in the wireless network (1000). At step S504, the method includes receiving the information response message comprising the feature specific RACH information corresponding to a feature specific RACH applied by the UE (100) for one of multiple features of a plurality of features and a specific feature of the plurality of features from the UE (100). The plurality of features includes the SDT, the coverage enhancement (i.e., msg3 repetition), the Redcap, and the network slicing. At step S506, the method includes optimizing the at least one network parameter related to RA based on the feature specific RACH information received from the UE (100) and the criteria for using the feature specific RACH.

FIG. 6 is a flow chart (S600) illustrating a scenario of logging and reporting feature specific random access information in the UE (100), according to the embodiments as disclosed herein. The operations (S602-S608) are handled by the feature specific RACH controller.

At step S602, the RACH completed successfully/RLF/CEF etc. The RACH is applied based on feature. The UE (100) is configured for the RACH report. At step S604, the method includes logging a list of features (e.g., SDT/RedCap, slicegroup/msg3 repetition) for which RACH is applied in the order of the feature priority and the feature priority in the RA report. At step S606, the method includes logging an additional RACH configuration, FeatureCombinationPreambles, RA Purpose and applied feature specific information in the RA report. At step S608, the method includes sending the logged RA report in the UE information response.

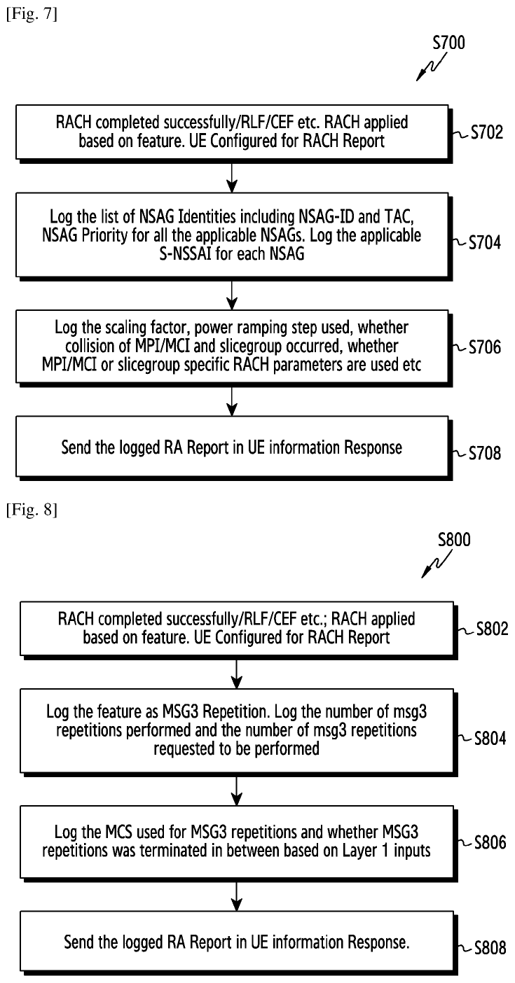

FIG. 7 is a flow chart (S700) illustrating a scenario of logging and reporting feature specific random access information in the UE (100) for the NSAG, according to the embodiments as disclosed herein. The operations (S702-S708) are handled by the feature specific RACH controller.

At step S702, the RACH completed successfully/RLF/CEF etc. The RACH is applied based on the feature. The UE (100) is configured for the RACH report. At step S704, the method includes logging the list of NSAG Identities including NSAG-ID and TAC, NSAG Priority for all the applicable NSAGs. The method includes logging the applicable S-NSSAI for each NSAG. At step S706, the method includes logging the scaling factor, power ramping step used, whether collision of MPI/MCI and slicegroup occurred, whether MPI/MCI or slicegroup specific RACH parameters are used etc. At step S708, the method includes sending the logged RA report in the UE information response.

FIG. 8 is a flow chart (S800) illustrating a scenario of logging and reporting feature specific random access information in the UE (100) for the msg3 repetitions, according to the embodiments as disclosed herein. The operations (S802-S808) are handled by the feature specific RACH controller.

At step S802, the RACH completed successfully/RLF/CEF etc. The RACH is applied based on the feature. The UE (100) is configured for the RACH report. At step S804, the method includes logging the feature as MSG3 Repetition. The method includes logging the number of msg3 repetitions performed and the number of msg3 repetitions requested to be performed. At step S806, the method includes logging the MCS used for MSG3 repetitions and whether MSG3 repetitions was terminated in between based on Layer 1 inputs. At step S808, the method includes sending the logged RA report in the UE information response.

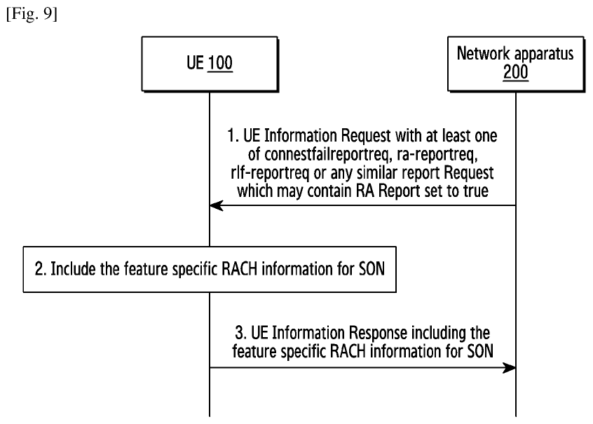

FIG. 9 illustrates a scenario of reporting feature specific RACH information to gNB, according to the embodiments as disclosed herein. At step 1, the base station sends the UE information request with at least one of connestfailreportreq, ra-reportreq, rlf-reportreq or any similar report request which may contain the RA report set to true. At step 2, the UE (100) includes the feature specific RACH information for the SON. At step 3, the UE (100) sends the UE information response including the feature specific RACH information for the SON to the base station.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a user equipment (UE) in a wireless communication system, the method comprising:
receiving, from a base station, a request message including information requesting a random access report, and
transmitting, to the base station, a response message including information that triggered a random access channel (RACH).

2. The method of claim 1,
wherein the response message includes a network slice access stratum group (NSAG) identity for the RACH.

3. The method of claim 1,
wherein the response message includes a NSAG priority for the RACH.

4. The method of claim 1,
wherein configuration information is received from the base station for the random access report, and the configuration information includes information on at least one of RACH configuration information, additional RACH configuration information, or feature combination preambles.

5. A method performed by a base station in a wireless communication system, the method comprising:
transmitting, to a user equipment (UE), a request message including information requesting a random access report, and
receiving, form the UE, a response message including information that triggered a random access channel (RACH).

6. The method of claim 5,
wherein the response message includes a network slice access stratum group (NSAG) identity for the RACH.

7. The method of claim 5,
wherein the response message includes a NSAG priority for the RACH.

8. The method of claim 5,
wherein configuration information is received from the base station for the random access report, and the configuration information includes information on at least one of RACH configuration information, additional RACH configuration information, or feature combination preambles.

9. A user equipment (UE) in a wireless communication system, the UE comprising:
a transceiver; and
at least one processor operatively coupled with the transceiver and configured to:
receive, from a base station, a request message including information requesting a random access report, and
transmit, to the base station, a response message including information that triggered a random access channel (RACH).

10. The method of claim 9,
wherein the response message includes a network slice access stratum group (NSAG) identity for the RACH.

11. The method of claim 9,
wherein the response message includes a NSAG priority for the RACH.

12. The method of claim 9,
wherein configuration information is received from the base station for the random access report, and the configuration information includes information on at least one of RACH configuration information, additional RACH configuration information, or feature combination preambles.

13. A base station in a wireless communication system, the base station comprising:
a transceiver; and
at least one processor operatively coupled with the transceiver and configured to:
transmit, to a user equipment (UE), a request message including information requesting a random access report, and
receive, form the UE, a response message including information that triggered a random access channel (RACH).

14. The method of claim 13,
wherein the response message includes a network slice access stratum group (NSAG) identity for the RACH.

15. The method of claim 13,
wherein the response message includes a NSAG priority for the RACH.
